(19) United States
(12) Patent Application Publication
(10) Pub. No.: US 2015/0346996 A1
(43) Pub. Date: Dec. 3, 2015

(54) ELECTRONIC APPARATUS AND METHOD

(71) Applicant: KABUSHIKI KAISHA TOSHIBA, Tokyo (JP)

(72) Inventors: Takehiro Ogawa, Hamura Tokyo (JP); Shinichi Oouchi, Ome Tokyo (JP)

(21) Appl. No.: 14/585,696

(22) Filed: Dec. 30, 2014

(30) Foreign Application Priority Data
May 28, 2014 (JP) 2014-110327

(51) Int. Cl. G06F 3/0488; G06F 3/0484

(52) U.S. Cl. CPC G06F 3/04883; G06F 3/04842

(57) ABSTRACT

According to one embodiment, an electronic apparatus includes circuitry. The circuitry is configured to display strokes handwritten on a screen and to display at least one character with a first font type corresponding to a recognition result of the strokes. The first font type is determined by using at least one of (i) whether a pressure is used for determining a form of the strokes and (ii) whether the strokes correspond to a cursive writing.

### CROSS-REFERENCE TO RELATED APPLICATIONS

This application is based upon and claims the benefit of priority from Japanese Patent Application No. 2014-110327, filed May 28, 2014, the entire contents of which are incorporated herein by reference.

### FIELD

Embodiments described herein relate generally to technology of inputting characters by handwriting.

### BACKGROUND

Recently, various kinds of electronic apparatuses, such as tablets, PDAs, and smartphones, have been developed. Such an electronic apparatus includes a touch screen display for facilitating an input operation by a user, and some of the electronic apparatuses have the function of allowing input by handwriting. The user can prepare a document including not only a text and images, but also handwritten characters and figures by the electronic apparatus.

Meanwhile, handwritten characters may be converted into a text (character code) by various kinds of character recognition processing to be used in a different application program. Since the converted text is displayed in a specific font, for example, the user may feel a sense of incongruity in a difference between a typeface of the handwritten characters and a typeface of the text.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic apparatus according to an embodiment.

FIG. 2 is an illustration showing an example of strokes handwritten on a touch screen display of the electronic apparatus of the embodiment.

FIG. 3 is an exemplary illustration for describing time-series information (stroke data) corresponding to the handwritten strokes of FIG. 2, which is stored on a storage medium by the electronic apparatus of the embodiment.

FIG. 4 is an exemplary block diagram showing a system configuration of the electronic apparatus of the embodiment.

FIG. 5 is an exemplary block diagram showing a functional configuration of a digital notebook application program executed by the electronic apparatus of the embodiment.

FIG. 6 is an illustration showing an example of reshaping characters constituted of strokes in which a pressure at the time of handwriting input is reflected by the electronic apparatus of the embodiment.

FIG. 7 is an illustration showing an example of reshaping characters constituted of strokes in which a pressure at the time of handwriting input is not reflected by the electronic apparatus of the embodiment.

FIG. 8 is an illustration showing an example of reshaping handwritten characters in cursive by the electronic apparatus of the embodiment.

FIG. 9 is a flowchart showing an example of steps of handwritten document reshaping processing executed by the electronic apparatus of the embodiment.

### DETAILED DESCRIPTION

Various embodiments will be hereinafter described with reference to the accompanying drawings. In general, according to one embodiment, an electronic apparatus includes circuitry. The circuitry is configured to display strokes handwritten on a screen and to display at least one character with a first font type corresponding to a recognition result of the strokes. The first font type is determined by using at least one of (i) whether a pressure is used for determining a form of the strokes and (ii) whether the strokes correspond to a cursive writing.

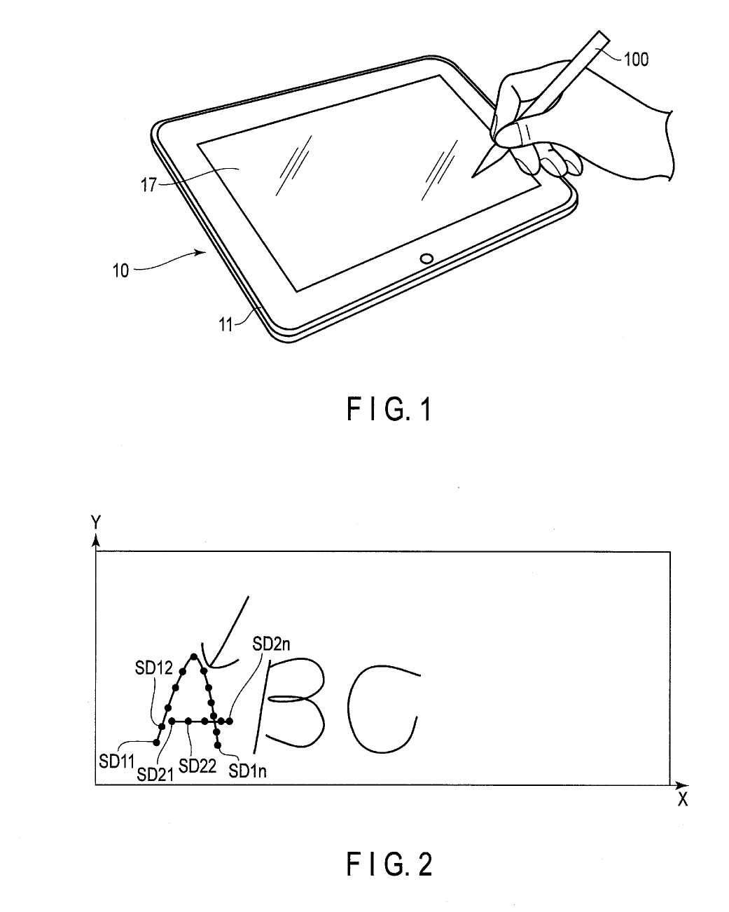

FIG. 1 is a perspective view showing an appearance of an electronic apparatus according to an embodiment. The electronic apparatus is a pen-based portable electronic apparatus capable of inputting data by handwriting with a stylus pen or a finger, for example. The electronic apparatus can be realized as a tablet computer, a notebook personal computer, a smartphone, a PDA, etc. It is hereinafter assumed that the electronic apparatus is realized as a tablet computer 10. The tablet computer 10 is a portable electronic apparatus which is also referred to as a tablet or a slate computer. The tablet computer 10 includes a main body 11 and a touch screen display 17, as shown in FIG. 1. The touch screen display 17 is arranged to be laid over a top surface of the main body 11.

The main body 11 includes a thin box-shaped housing. In the touch screen display 17, a flat-panel display, and a sensor configured to detect a contact position of the stylus pen or the finger on a screen of the flat-panel display are incorporated. The flat-panel display may be, for example, a liquid crystal display (LCD). As the sensor, a capacitive touch panel or an electromagnetic induction-type digitizer, for example, can be used. It is hereinafter assumed that both of the two types of sensors, i.e., a digitizer and a touch panel, are incorporated into the touch screen display 17.

Each of the digitizer and the touch panel is provided to cover the screen of the flat-panel display. The touch screen display 17 can detect not only a touch operation on the screen using a finger, but also a touch operation on the screen using a stylus pen 100. The stylus pen 100 is an electromagnetic induction stylus pen, for example.

A user can perform a handwriting input operation of inputting a plurality of strokes by handwriting on the touch screen display 17 by using an external object (the stylus pen 100 or finger). During the handwriting input operation, a locus of movement of the external object (the stylus pen 100 or finger) on the screen, that is, a locus of a stroke (a trace of handwriting) handwritten by the handwriting input operation, is drawn in real time, and the locus of each stroke is thereby displayed on the screen. A locus of movement of the external object while the external object is in contact with the screen corresponds to one stroke. A set of many strokes, that is, a set of many loci (traces of handwriting) constitutes handwritten characters or figures.

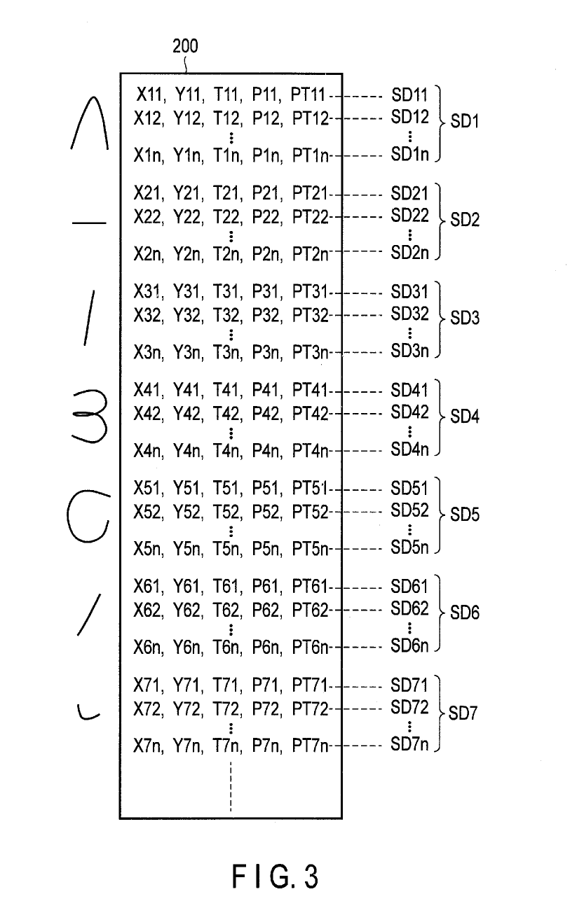

In the present embodiment, such handwritten strokes are stored on a storage medium not as image data, but as time-series information indicative of coordinate series of the loci of strokes and the order relation between the strokes. Details of the time-series information will be described later with reference to FIG. 3, but the time-series information is generally intended as a set of time-series stroke data items corresponding to strokes, respectively. Each item of stroke data may be any kind of data as long as it can express a certain stroke which can be input by handwriting. The stroke data includes, for example, coordinate data series (time-series coordinates) corresponding to points on the locus of the stroke. The order of arrangement of these items of stroke data corresponds to the order in which each of the strokes was handwritten, that is the order of strokes.

The tablet computer 10 can read existing arbitrary handwritten document (text) data from the storage medium, and display a document (text) corresponding to this handwritten document data, that is, a handwritten document on which loci corresponding to strokes indicated by the time-series information are drawn, on the screen.

Next, with reference to FIGS. 2 and 3, a relationship between strokes (handwritten characters, marks, figures, tables, etc.) handwritten by a user and the time-series information will be described. FIG. 2 shows an example of a text handwritten on the touch screen display 17 by using the stylus pen 100 or the like.

In such a text, on top of a handwritten character or figure, etc., another character or figure is often handwritten. In FIG. 2, it is assumed that a character string “ABC” is handwritten in the order of “A”, “B”, and “C”, and then an arrow is handwritten very close to the handwritten character “A”.

The handwritten character “A” is represented by two strokes (a locus in the form of “Λ” and a locus in the form of “-”) which are handwritten by using the stylus pen 100 or the like, that is, by two loci. The locus of the stylus pen 100 in the form of “Λ” which is handwritten first is sampled in real time at regular time intervals, for example. In this way, time-series coordinates SD11, SD12 . . . SD1n of the “Λ” stroke are obtained. Similarly, the locus of the stylus pen 100 in the form of “-” which is handwritten next is also sampled, and time-series coordinates SD21, SD22 . . . SD2n of the “-” stroke are thereby obtained.

The handwritten character “B” is represented by two strokes which are handwritten by using the stylus pen 100 or the like, that is, by two loci. The handwritten character “C” is represented by a single stroke which is handwritten by using the stylus pen 100 or the like, that is, by one locus. The handwritten arrow is represented by two strokes which are handwritten by using the stylus pen 100 or the like, that is, by two loci.

FIG. 3 illustrates time-series information 200 corresponding to the text of FIG. 2. Time-series information 200 includes a plurality of items of stroke data SD1, SD2 . . . SD7. In the time-series information 200, these items of stroke data SD1, SD2 . . . SD7 are arranged in the order of trace of handwriting, that is, in the chronological order of strokes handwritten.

In the time-series information 200, the first two items of stroke data SD1 and SD2 indicate two strokes that constitute the handwritten character “A”, respectively. The third and the fourth items of stroke data SD3 and SD4 indicate two strokes that constitute the handwritten character “B”, respectively. The fifth item of stroke data SD5 indicates a single stroke that constitutes the handwritten character “C”. The sixth and the seventh items of stroke data SD6 and SD7 indicate two strokes that constitute the handwritten arrow, respectively.

Each item of stroke data includes coordinate data series (time-series coordinates) corresponding to one stroke, that is, a plurality of coordinates corresponding to a plurality of points on a locus of the stroke. In each item of the stroke data, the plurality of coordinates are arranged chronologically in the order of strokes written. For example, with respect to the handwritten character “A”, stroke data SD1 includes coordinate data series (time-series coordinates) corresponding to the points on the locus of the “Λ” stroke of the handwritten character “A”, that is, n items of coordinate data SD11, SD12, . . . , SD1n. Stroke data SD2 includes coordinate data series corresponding to the points on the locus of the “-” stroke of the handwritten character “A”, that is, n items of coordinate data SD21, SD22, . . . , SD2n. The number of items of coordinate data may be different for each stroke data depending on the length of the stroke.

Each item of coordinate data indicates an X-coordinate and a Y-coordinate corresponding to a certain point in the relevant locus. For example, coordinate data SD11 indicates the X-coordinate (X11) and the Y-coordinate (Y11) of the starting point of the “Λ” stroke. SD1n indicates the X-coordinate (X1n) and the Y-coordinate (Y1n) of the end point of the “Λ” stroke.

Also, each item of coordinate data may include time stamp information T representing the point of time when a point corresponding to the coordinates was handwritten. The point of time at which the point was handwritten may be either an absolute time (for example, year, month, day, hour, minute, and second), or a relative time with reference to a certain point of time. For example, the absolute time (for example, year, month, day, hour, minute, and second) when a stroke was started to be written may be added to each item of stroke data as time stamp information, and the relative time indicating a difference from the absolute time may be added as time stamp information T to each item of coordinate data in the stroke data. By using the time-series information obtained by adding the time stamp information T to each item of coordinate data, a temporal relationship between strokes can be more accurately represented.

Further, each item of coordinate includes pressure P caused by the external object (for example, the stylus pen 100) touching the screen, and pen type PT representing the type of pen used for input by handwriting at the point of time when a point corresponding to the coordinates was handwritten. For the pen type PT, one of a plurality of types of pen such as a fountain pen, a brush, a pencil, a ball-point pen, and a marker, is designated.

Pen types PT are classified into a pen type for which a line width of a stroke displayed varies depending on pressure P (for example, a fountain pen, a brush, etc.), and a pen type for which a line width of a stroke displayed remains the same regardless of pressure P (for example, a pencil, a ball-point pen, a marker, etc.). That is, a stroke input by handwriting is displayed with a line width based on pressure P if the pen type for which the line width varies depending on pressure P is designated, and displayed with a constant line width regardless of pressure P if the pen type for which the line width remains the same regardless of pressure P is designated. A pen type is designated by a user who uses a digital notebook application program 202, for example, with a button (GUI), etc., for selecting the pen type.

In the present embodiment, as described above, a handwritten stroke is stored not as an image or a result of character recognition, but as the time-series information 200 which is constituted of a set of time-series stroke data. Accordingly, it is possible to deal with a handwritten character or figure irrespective of a language. Thus, a structure of the time-series information 200 of the present embodiment can be used in common in various countries all over the world where different languages are used.

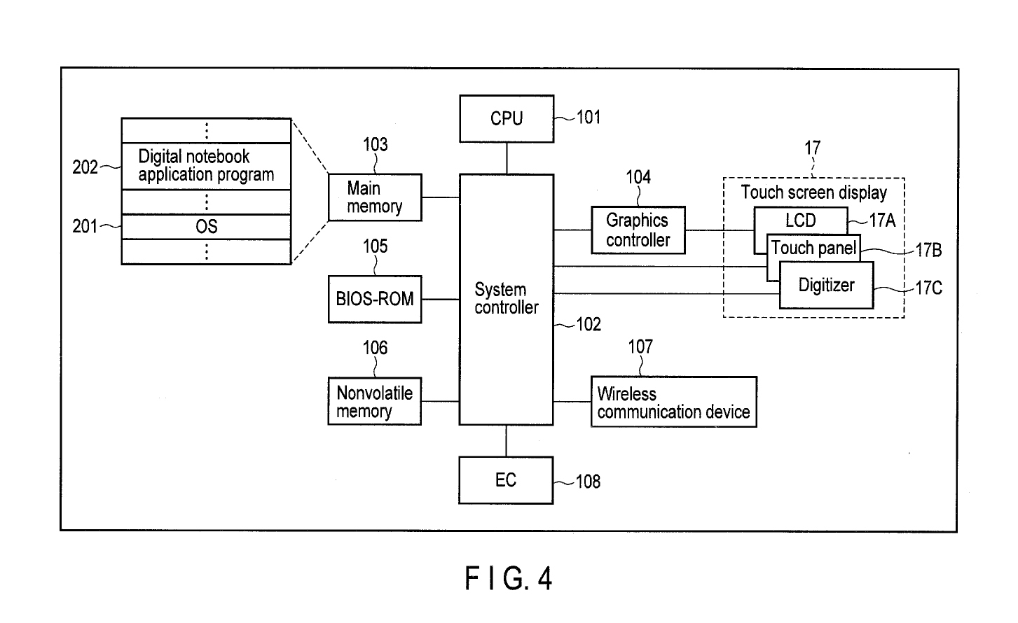

FIG. 4 is a diagram showing a system configuration of the tablet computer 10.

As shown in FIG. 4, the tablet computer 10 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor circuitry for controlling the operation of various components in the tablet computer 10. The CPU 101 executes various kinds of software loaded into the main memory 103 from the nonvolatile memory 106, which is a storage device. These kinds of software include an operating system (OS) 201, and various application programs. The application programs include the digital notebook application program 202. The digital notebook application program 202 includes a handwriting input function for writing a character or drawing a figure by hand based on an operation of using the touch screen display 17, etc., a handwritten document reshaping function of reshaping a handwritten document, and the like. The digital notebook application program 202 converts, for example, a handwritten character into a text (character code) by the handwritten document reshaping function.

Further, the CPU 101 executes a Basic Input/Output System (BIOS) stored in the BIOS-ROM 105. The BIOS is a program for controlling hardware.

The system controller 102 is a device connecting between a local bus of the CPU 101 and various components. In the system controller 102, a memory controller for access controlling the main memory 103 is also integrated. Also, the system controller 102 has the function of communicating with the graphics controller 104 via a serial bus conforming to the PCI EXPRESS standard.

The graphics controller 104 is a display controller for controlling an LCD 17A used as a display monitor of the tablet computer 10. A display signal generated by the graphics controller 104 is transmitted to the LCD 17A. The LCD 17A displays a screen image based on the display signal. A touch panel 17B and a digitizer 17C are arranged on top of the LCD 17A. The touch panel 17B is a capacitive pointing device for inputting data on a screen of the LCD 17A. A contact position on the screen touched by a finger and movement and the like of the contact position are detected by the touch panel 17B. The digitizer 17C is an electromagnetic induction-type pointing device for inputting data on the screen of the LCD 17A. A contact position on the screen touched by the stylus pen 100, movement of the contact position, contact pressure, and the like are detected by the digitizer 17C.

The wireless communication device 107 is a device configured to execute wireless communication such as a wireless LAN or 3G mobile communications. The EC 108 is a one-chip microcomputer including an embedded controller for power management. The EC 108 has the function of powering the tablet computer 10 on or off in accordance with an operation of a power button by the user.

A handwritten document including characters input by handwriting by using the above-mentioned system configuration may be converted into a text (character code) through various kinds of character recognition processing so that it can be used in a different application program (for example, word processing software, presentation software, and a mailer). The converted text is displayed on the screen using, for example, a certain typeface (for example, a font of sans serif typeface).

When a character is input by handwriting in a block letter and by a pen type for which a line width remains the same regardless of pressure P caused by the external object (stylus pen 100) touching the screen, a stroke of the handwritten character is displayed with a constant line width regardless of pressure P. Accordingly, a text corresponding to the handwritten characters can be displayed, for example, in a font of sans serif typeface which has a constant line width and does not have embellishment at end portions without causing a sense of incongruity.

However, depending on the selected pen type, a stroke which constitutes the character input by handwriting may be displayed with a line width based on pressure P generated by the external object (stylus pen 100) touching the screen. Also, it is possible that the character input by handwriting will be a character in cursive.

In such a case, the user may feel a sense of incongruity in a converted text obtained from the handwritten characters when it is displayed in a font of sans serif typeface which has a constant line width and does not have embellishment at end portions. For example, when a character (stroke) input by handwriting while varying the line width, which is achieved by changing the pressure P of the stylus touching the screen when using a fountain pen type, is displayed as a text with a typeface having a constant line width such as Gothic type, the user may feel a sense of incongruity in a difference between the typeface of the handwritten character and the typeface of the corresponding text. Further, for example, when a handwritten character in cursive is displayed as a text in a font of block letters, the user may feel a sense of incongruity in a difference between the typeface of the handwritten character and the typeface of the corresponding text.

Accordingly, in the present embodiment, by using a typeface which is determined based on at least one of whether pressure P at the time of handwriting input is reflected in display of a stroke and whether a stroke corresponds to a character in cursive, a character recognized from the stroke is displayed on the screen. More specifically, when a stroke corresponds to a character in cursive, a recognized character is displayed on the screen with a typeface corresponding to a cursive style (i.e., script typeface). Further, when pressure P at the time of handwriting input is reflected in display of a stroke, a recognized character is displayed with a typeface for which a thickness of a line which constitutes the character varies (i.e., a serif typeface), and when pressure P at the time of handwriting input is not reflected in display of a stroke, a recognized character is displayed with a typeface for which a thickness of a line which constitutes the character does not vary (i.e., sans serif typeface).

In this way, a text corresponding to the handwritten characters can be displayed without causing a sense of incongruity.

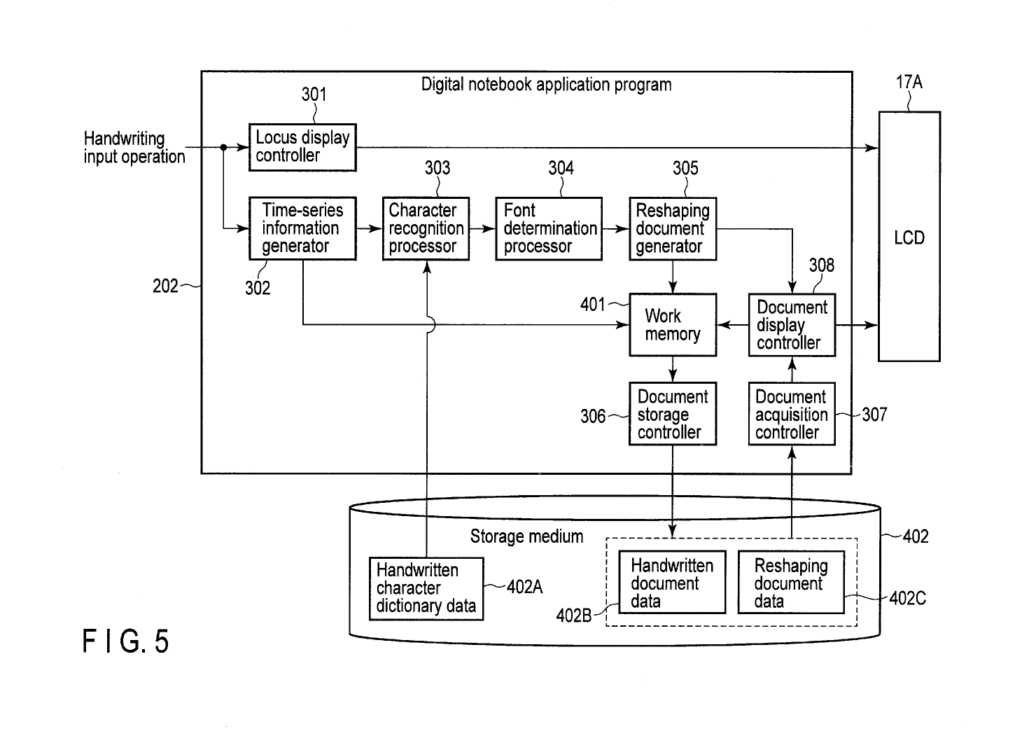

FIG. 5 shows an example of a functional configuration of the digital notebook application program 202 executed by the tablet computer 10. The digital notebook application program 202 displays a handwritten character string, reshapes the handwritten character string, and so on, by using the time-series information (stroke data) input by an operation which uses the touch screen display 17.

The digital notebook application program 202 includes, for example, a locus display controller 301, a time-series information generator 302, a character recognition processor 303, a font determination processor 304, a reshaping document generator 305, a document storage controller 306, a document acquisition controller 307, and a document display controller 308.

The touch screen display 17 is configured to detect an occurrence of an event such as “touch”, “move (slide)”, and “release”. The event “touch” indicates that an external object has touched the screen. The event “move (slide)” indicates that a contact position has moved while the external object is touching the screen. The event “release” indicates that the external object has been separated from the screen.

The locus display controller 301 and the time-series information generator 302 receive the event of “touch”, “move (slide)”, or “release” generated by the touch screen display 17, and thereby detect a handwriting input operation. The “touch” event includes coordinates of the contact position of the external object. The “move (slide)” event includes coordinates of a new contact position where the external object has moved. The “release” event includes coordinates of a position where the contacting external object is released from the screen. Accordingly, the locus display controller 301 and the time-series information generator 302 can receive coordinate series corresponding to a locus of the movement of the contact position from the touch screen display 17.

The locus display controller 301 displays one or more strokes (which will be hereinafter also referred to as one or more first strokes) to be input by handwriting on a screen of the touch screen display 17 on screen. The locus display controller 301 receives the coordinate series from the touch screen display 17, and displays a locus of each stroke which is handwritten by the handwriting input operation using the stylus pen 100, etc., on the screen of the LCD 17A in the touch screen display 17, based on the aforementioned coordinate series. By the locus display controller 301, a locus of the stylus pen 100 while the stylus pen 100 is touching the screen, that is, a stroke, is drawn on the screen of the LCD 17A.

The time-series information generator 302 receives the aforementioned coordinate series output from the touch screen display 17, and based on the coordinate series, generates the times-series information (stroke data) having the structure as described in detail in FIG. 3. In this case, the time-series information, that is, the coordinates corresponding to each point of the stroke, the time stamp information, the pen type information, and the pressure, may be temporarily stored in a work memory 401.

Also, the time-series information generator 302 outputs the generated time-series information (stroke data) to the character recognition processor 303. Further, in accordance with a request of reshaping a handwritten document being displayed, the character recognition processor 303 may read the time-series information corresponding to the handwritten document from the work memory 401 or a storage medium 402.

The character recognition processor 303 recognizes one or more first characters corresponding to the one or more first strokes input by handwriting. The one or more first strokes can correspond to one character. Also, one stroke can correspond to a plurality of characters.

More specifically, firstly, the character recognition processor 303 calculates a feature amount (first feature amount) corresponding to a stroke by using the stroke data corresponding to the stroke input by handwriting. The character recognition processor 303 calculates the feature amount based on the form of the stroke and an orientation of the handwritten stroke.

Then, the character recognition processor 303 calculates a degree of similarity between a character constituted by a stroke input by handwriting and each of characters in handwritten character dictionary data 402A by using the first feature amount which has been calculated, and second feature amounts corresponding to the characters in the handwritten character dictionary data 402A. The handwritten character dictionary data 402A includes data on the feature amounts of various characters to be handwritten, and is generated by, for example, analyzing the stroke data corresponding to handwritten strokes and handwritten document data 402B. Also, the handwritten character dictionary data 402A includes not only the feature amounts of characters handwritten in block letters, but also the feature amounts of characters handwritten in cursive style. Accordingly, the character recognition processor 303 can appropriately distinguish between a character in a block letter and a character in cursive from the stroke which has been input by handwriting. Also, the character recognition processor 303 can identify whether the character constituted by a stroke input by handwriting is a character in a block letter or a character in cursive. Further, since the handwritten character dictionary data 402A is generated per user, for example, it is possible to reflect the feature of handwritten characters for each user.

The character recognition processor 303 calculates a degree of similarity between the first feature amount corresponding to a stroke input by handwriting and each of the second feature amounts corresponding to handwritten characters indicated in the handwritten character dictionary data 402A, for example. Further, the character recognition processor 303 detects a character having the highest degree of similarity from the characters in the handwritten character dictionary data 402A, and determines that character as being the one or more first characters corresponding to the one or more first strokes input by handwriting.

After that, the font determination processor 304 determines the typeface (font) to be used for displaying the recognized character. The font determination processor 304 determines the typeface to be used for displaying the one or more first characters corresponding to a result of recognition of the one or more first strokes based on at least one of whether pressure P at the time of handwriting input is reflected in the display of the one or more first strokes input by handwriting and whether the one or more first strokes correspond to a character in cursive. The determined typeface is, for example, one of a typeface for which a thickness of a line which constitutes the character varies (for example, a serif typeface), a typeface for which a thickness of a line which constitutes the character does not vary (for example, a sans serif typeface), and a typeface in cursive style (for example, a script typeface).

More specifically, when the one or more first strokes correspond to a character in cursive, the font determination processor 304 determines that a font of a typeface corresponding to a cursive style (a font of script typeface) should be used for displaying the recognized one or more first characters. For example, when at least one stroke of the one or more first strokes input by handwriting corresponds to a plurality of characters (that is, when a plurality of characters are recognized from a single stroke), the font determination processor 304 determines that a font of a typeface corresponding to a cursive style should be used for displaying the recognized characters. The font determination processor 304 may determine that a font of a typeface corresponding to a cursive style is to be used for a plurality of characters that constitute a line, a term, or the like.

Further, when pressure P at the time of handwriting input is reflected in the display of the one or more first strokes, the font determination processor 304 determines that a font of a typeface for which a thickness of a line (line width) which constitutes the character varies (i.e., a font of serif typeface) should be used for displaying the recognized one or more first characters. Furthermore, when a stroke corresponds to a character (second character), and pressure P at the time of handwriting input is reflected in the display of the stroke, the font determination processor 304 may determine that a font of a typeface for which a thickness of a line which constitutes the character varies is to be used for the display of that character. That is, the font determination processor 304 may determine using a font of a typeface for which a thickness of a line which constitutes the character varies on a character-by-character basis. In addition, when pressure P at the time of handwriting input is reflected in the display of a stroke, the font determination processor 304 may determine using a font of a typeface for which a thickness of a line which constitutes the character varies and which has embellishment at an end portion of the line for the display of the recognized character.

Further, when pressure P at the time of handwriting input is not reflected in the display of the one or more first strokes, the font determination processor 304 determines that a font of a typeface for which a thickness of a line which constitutes a character does not vary (i.e., a font of sans serif typeface) should be used for displaying the recognized one or more first characters. Furthermore, when a stroke corresponds to a character (second character), and pressure P at the time of handwriting input is not reflected in the display of the stroke, the font determination processor 304 may determine that a font of a typeface for which a thickness of a line which constitutes the character does not vary is to be used for the display of that character. That is, the font determination processor 304 may determine using a font of a typeface for which a thickness of a line which constitutes the character does not vary on a character-by-character basis. In addition, when pressure P at the time of handwriting input is not reflected in the display of a stroke, the font determination processor 304 may determine using a font of a typeface for which a thickness of a line which constitutes the character does not vary and which does not have embellishment at an end portion of the line for the display of the recognized character.

The reshaping document generator 305 generates reshaping document data 402C including data in which a character recognized from a handwritten document being displayed is associated with a typeface (font) to be used for displaying that character. The reshaping document generator 305 can generate the reshaping document data 402C in a format (external format) conforming to another application program in which the reshaped document is used. The reshaping document generator 305 may temporarily store the generated reshaping document data 402C in the work memory 401.

Also, the document storage controller 306 can store the generated reshaping document data (the reshaping document data which has been temporarily stored in the work memory 401) 402C on the storage medium 402. The storage medium 402 is a storage device in the tablet computer 10, for example.

The document display controller 308 displays the reshaped document on the screen of the LCD 17A by using the generated reshaping document data 402C. In this way, characters (text) recognized from the handwritten document can be displayed in a font of a typeface suitable for those characters.

Also, the document acquisition controller 307 reads an already-stored arbitrary item of the reshaping document data 402C from the storage medium 402. The read reshaping document data 402C is transmitted to the document display controller 308. The document display controller 308 displays a document (a page) including a text corresponding to data in which a character code and a typeface (font) are associated with each other, which is included in the reshaping document data 402C, on the screen.

Further, the document storage controller 306 stores stroke data which has been generated (stroke data temporarily stored in the work memory 401) on the storage medium 402 as the handwritten document data 402B. The storage medium 402 is a storage device in the tablet computer 10, for example.

The document acquisition controller 307 can also read an already-stored arbitrary item of the handwritten document data 402B from the storage medium 402. The read handwritten document data 402B is transmitted to the document display controller 308. The document display controller 308 analyzes the handwritten document data 402B, and based on a result of this analysis, displays a document (a page) including a locus of each stroke indicated by the stroke data (time-series information) on the screen.

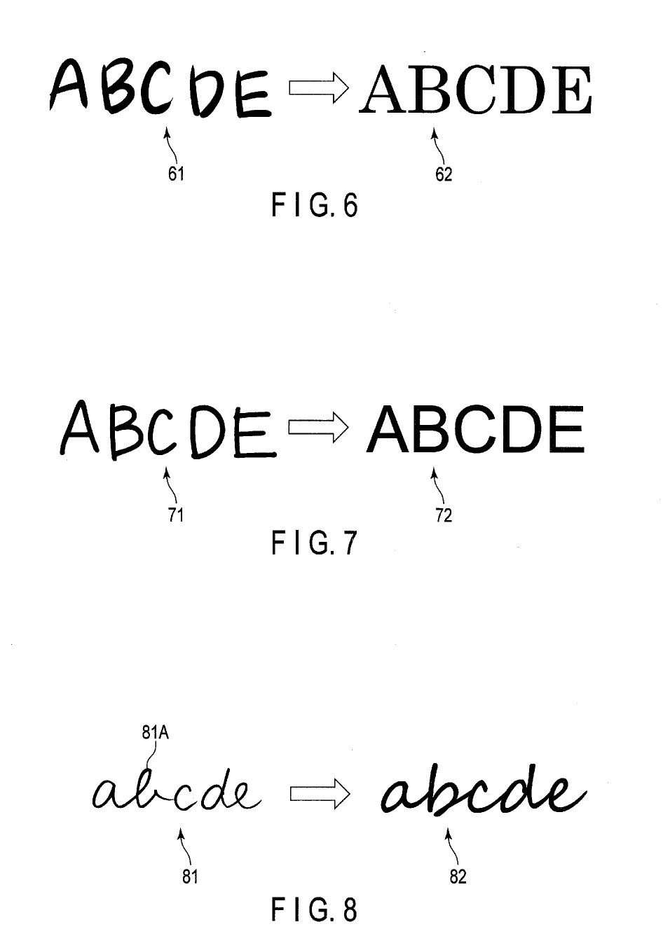

Next, with reference to FIGS. 6 to 8, an example of displaying a text (character code), which corresponds to characters (strokes) input by handwriting by using a typeface which is determined based on at least one of whether pressure P at the time of handwriting input is reflected in display of the strokes and whether the strokes correspond to characters in cursive, will be described.

FIG. 6 shows an example in which a text corresponding to characters input by handwriting with a pen of the type having writing pressure response is displayed in a font of a typeface for which thicknesses of lines which constitute the characters vary. Strokes 61, which constitute the characters input by handwriting with the pen of the type having writing pressure response, are displayed with a line width based on pressure P at the time of handwriting input. That is, pressure P at the time of handwriting input is reflected in the strokes 61.

Therefore, a text 62 recognized from the characters input by handwriting can be displayed without causing a sense of incongruity by using a font of a typeface for which thicknesses of lines which constitute the characters vary. Fonts of typefaces for which the thicknesses of the lines which constitute the characters vary are, for example, fonts of serif typefaces (for example, Times New Roman, Mincho, etc.).

FIG. 7 shows an example in which a text corresponding to characters input by handwriting with a pen of the type having no writing pressure response is displayed in a font of a typeface for which thicknesses of lines which constitute the characters do not vary. Strokes 71, which constitute the characters input by handwriting with a pen of the type having no writing pressure response, are displayed with a constant line width regardless of pressure P at the time of handwriting input. That is, pressure P at the time of handwriting input is not reflected in the strokes 71.

Therefore, a text 72 recognized from the characters input by handwriting can be displayed without causing a sense of incongruity by using a font of a typeface for which thicknesses of lines which constitute the characters do not vary. Fonts of typefaces for which the thicknesses of the lines which constitute the characters do not vary are, for example, fonts of sans serif typefaces (for example, Gothic).

Also, FIG. 8 shows an example in which a text corresponding to characters input by handwriting in cursive style is displayed in a font of a typeface in cursive style. A stroke corresponding to a character input by handwriting in cursive style can also correspond to a plurality of characters. For example, handwritten characters “ab” in cursive shown in FIG. 8 correspond to a single stroke 81A. In contrast, with respect to the handwritten characters in block letters shown in FIGS. 6 and 7, a single stroke does not correspond to a plurality of characters.

Accordingly, when one or more first strokes 81 input by handwriting (for example, one or more first strokes 81 included in a certain line) include at least one stroke 81A corresponding to a plurality of characters, a text 82 recognized from the characters input by handwriting can be displayed without causing a sense of incongruity by using a font of a typeface in cursive style. Fonts of typefaces in cursive style are, for example, fonts of script typefaces.

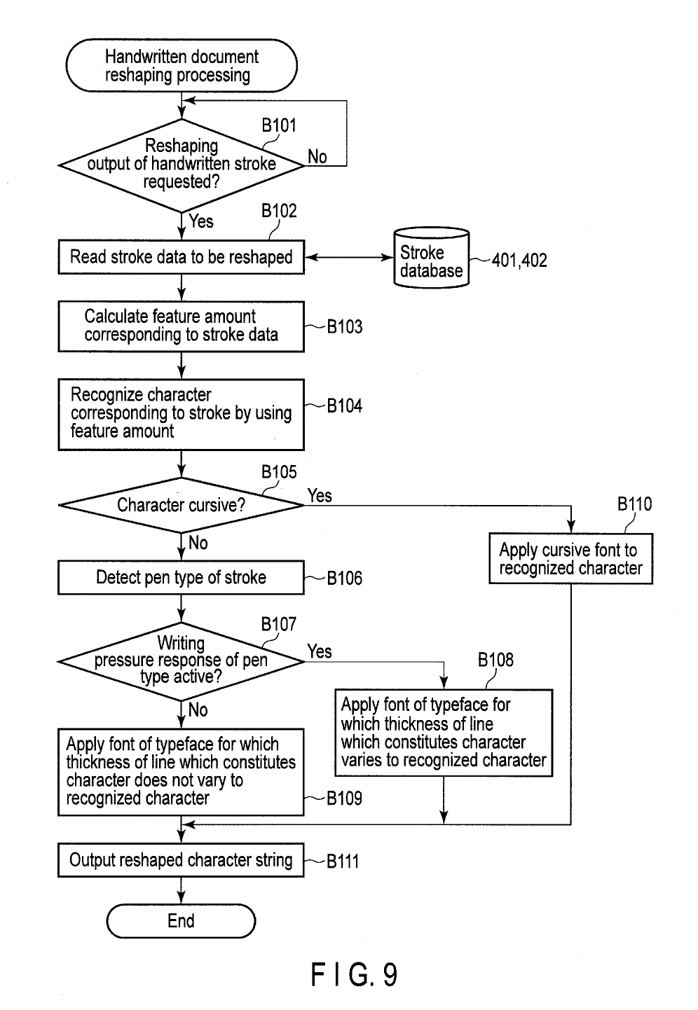

Next, with reference to a flowchart of FIG. 9, an example of steps of handwritten document reshaping processing executed by the tablet computer 10 will be described.

Firstly, the character recognition processor 303 determines whether reshaping output of a stroke input by handwriting is requested or not (block B101). The character recognition processor 303 determines that the reshaping output of the stroke input by handwriting is requested, in accordance with pressing of a button (GUI) for requesting the reshaping output displayed on the screen, for example. When reshaping output of the stroke input by handwriting is not requested (NO in block B101), the processing returns to block B101, and whether reshaping output of a stroke input by handwriting is requested is determined again.

When the reshaping output of the stroke input by handwriting is requested (YES in block B101), the character recognition processor 303 reads stroke data (time-series information) corresponding to the stroke to be reshaped from a stroke database (stroke DB) (block B102). The stroke DB is, for example, the work memory 401 in which the stroke data is stored, and the storage medium 402 on which the handwritten document data 402B including the stroke data is stored. Further, the character recognition processor 303 may use the stroke data generated by the time-series information generator 302 as stroke data corresponding to strokes to be reshaped.

The character recognition processor 303 calculates a feature amount corresponding to the stroke data (block B103), and recognizes a character corresponding to the stroke by using the feature amount (block B104). The character recognition processor 303 recognizes a character corresponding to the stroke by using, for example, the handwritten character dictionary data 402A stored on the storage medium 402.

After that, the font determination processor 304 determines whether the stroke corresponds to a character in cursive (that is, whether a character recognized from the stroke is a character in cursive or not) (block B105). When a plurality of characters are recognized from a single stroke, for example, the character recognition processor 303 determines that the characters recognized from the stroke are characters in cursive. When the stroke corresponds to a character in cursive (YES in block B105), the font determination processor 304 applies a font in cursive style (a font of script typeface) to the recognized characters (block B110).

When the stroke does not correspond to a character in script (NO in block B105), the font determination processor 304 detects a pen type of the stroke (block B106). The font determination processor 304 detects the pen type of the stroke by using pen type data included in the stroke data. Further, the font determination processor 304 determines whether the detected pen type is a pen type having active writing pressure response (block B107). A pen type having active writing pressure response is that to which a pen capable of varying a line width depending on contact pressure P at the time of handwriting input belongs, and pens such as a fountain pen and a brush are included. Meanwhile, a pen type having inactive writing pressure response is that to which a pen which does not vary a line width by contact pressure P at the time of handwriting input belongs, and pens such as a pencil, a ball-point pen, and a marker, are included.

When the detected pen type is a pen type having active writing pressure response (YES in block B107), the font determination processor 304 applies a font of a typeface for which a thickness of a line which constitutes the character varies to the recognized character (block B108). Also, when the detected pen type is a pen type having inactive writing pressure response (NO in block B107), the font determination processor 304 applies a font of a typeface for which a thickness of a line which constitutes the character does not vary to the recognized character (block B109).

Further, the reshaping document generator 305 and the document display controller 308 output (display) a character reshaped by the application of the font (block B111). For example, the reshaping document generator 305 generates the reshaping document data 402C including the reshaped characters, and the document display controller 308 displays a reshaped document based on the generated reshaping document data 402C on the screen. The reshaping document data 402C includes, for example, data indicating a character code corresponding to the recognized character, and a font (typeface) to be used for displaying the character code.

As described above, according to the present embodiment, it is possible to display a text corresponding to handwritten characters without causing a sense of incongruity. The locus display controller 301 displays one or more first strokes input by handwriting on the screen of the LCD 17A. The character recognition processor 303, the font determination processor 304, the reshaping document generator 305, and the document display controller 308 display the one or more first characters corresponding to a result of recognition of the one or more first strokes by using a typeface determined based on at least one of whether a pressure at the time of handwriting input is reflected in display of the one or more first strokes and whether the one or more first strokes correspond to a character in cursive. In this way, a text recognized from the strokes input by handwriting can be displayed with a typeface according to the typeface of the strokes (characters) input by handwriting, thereby preventing a sense of incongruity from being caused due to a difference in the typeface.

It should be noted that all of the steps of the handwritten document reshaping processing of the present embodiment can be executed by software. Accordingly, it is possible to easily realize an advantage similar to that of the present embodiment by simply installing a program for executing the steps of the handwritten document reshaping processing on a computer by way of a computer-readable storage medium having stored thereon the program, and executing the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
circuitry configured to:
display strokes handwritten on a screen; and
display at least one character with a first font type corresponding to a recognition result of the strokes, the first font type determined by using at least one of whether a pressure is used for determining a form of the strokes and whether the strokes correspond to a cursive writing.

2. The apparatus of claim 1, wherein
the circuitry is further configured to display at least one character with the typeface of:
a variable thickness when the pressure is used for determining a form of the strokes; and
a consistent thickness when the pressure is not used for determining a form of the strokes.

3. The apparatus of claim 1, wherein
the circuitry is further configured to display a character of the at least one character with the typeface of:
a variable thickness when the pressure is used for determining a form of the strokes corresponding to the character; and
a consistent thickness when the pressure is not used for determining a form of the strokes corresponding to the character.

4. The apparatus of claim 1, wherein the circuitry is further configured to display at least one character with the typeface corresponding to a cursive style when the strokes correspond to a cursive writing.

5. The apparatus of claim 1, wherein the circuitry is further configured to display at least one character with the typeface corresponding to a cursive style when the at least one character is recognized from at least one stroke of the strokes.

6. The apparatus of claim 1, wherein the strokes correspond to real-time handwriting.

7. A method comprising:
displaying strokes handwritten on a screen; and
displaying at least one character with a first font type corresponding to a recognition result of the strokes, the first font type determining by using at least one of whether a pressure is used for determining a form of the strokes and whether the strokes correspond to a cursive writing.

8. The method of claim 7, further comprising:
displaying at least one character with the typeface of:
a variable thickness when the pressure is used for determining a form of the strokes; and
a consistent thickness when the pressure is not used for determining a form of the strokes.

9. The method of claim 7, further comprising:
displaying a character of the at least one character with the typeface of:
a variable thickness when the pressure is used for determining a form of the strokes corresponding to the character; and
a consistent thickness when the pressure is not used for determining a form of the strokes corresponding to the character.

10. The method of claim 7, further comprising:
displaying at least one character with the typeface corresponding to a cursive style when the strokes correspond to a cursive writing.

11. The method of claim 7, further comprising:
displaying at least one character with the typeface corresponding to a cursive style when the at least one character is recognized from at least one stroke of the strokes.

12. A non-transitory computer-readable medium storing a computer program that causes circuitry to execute:
displaying strokes handwritten on a screen; and
displaying at least one character with a first font type corresponding to a recognition result of the strokes, the first font type determined by using at least one of whether a pressure is used for determining a form of the strokes and whether the strokes correspond to a cursive writing.

13. The computer-readable medium of claim 12, wherein the circuitry execute:
displaying at least one character with the typeface of:
a variable thickness when the pressure is used for determining a form of the strokes; and
a consistent thickness when the pressure is not used for determining a form of the strokes.

14. The computer-readable medium of claim 12, wherein the circuitry further executes:
displaying a character of the at least one character with the typeface of:
a variable thickness when the pressure is used for determining a form of the strokes corresponding to the character; and
a consistent thickness when the pressure is not used for determining a form of the strokes corresponding to the character.

15. The computer-readable medium of claim 12, wherein the circuitry further executes:
displaying at least one character with the typeface corresponding to a cursive style when the strokes correspond to a cursive writing.

16. The computer-readable medium of claim 12, wherein the circuitry further executes:
displaying at least one character with the typeface corresponding to a cursive style when the at least one character is recognized from at least one stroke of the strokes.
